(19) United States
(12) Patent Application Publication
(10) Pub. No.: US 2024/0063490 A1
(43) Pub. Date: Feb. 22, 2024

(54) TRACTION BATTERY PACK ENCLOSURE INTUMESCENT SEAL SHIELDING ASSEMBLY AND SEAL SHIELDING METHOD

(71) Applicant: Ford Global Technologies, LLC, Dearborn, MI (US)

(72) Inventors: Nathaniel Conti, Canton, MI (US); Parikshit S. Gupte, West Bloomfield, MI (US)

(21) Appl. No.: 17/890,372

(22) Filed: Aug. 18, 2022

(51) Int. Cl. H01M 50/244; H01M 50/209; H01M 50/271; H01M 10/658; H01M 50/249

(52) U.S. Cl. CPC H01M 50/244; H01M 50/209; H01M 50/271; H01M 10/658; H01M 50/249; H01M 2220/20

(57) ABSTRACT

An assembly includes a first piece and a second piece of an enclosure having an interior area. The first piece includes a first flange that projects outward from the interior area. The second piece includes a second flange that projects outward from the interior area. The assembly further includes a gasket seal and an intumescent. The gasket seal is sandwiched between the first and second flanges. The intumescent is sandwiched between the first and second flange at a position that is between the gasket seal and the interior area.

### TECHNICAL FIELD

This disclosure relates generally to sealing interfaces of a traction battery enclosure.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to an assembly, including: a first piece of an enclosure having an interior area, the first piece including a first flange that projects outward from the interior area, a second piece of the enclosure, the second piece including a second flange that projects outward from the interior area; and a gasket seal sandwiched between the first and second flanges; and an intumescent sandwiched between the first and second flange at a position that is between the gasket seal and the interior area.

In some aspects, the techniques described herein relate to an assembly, further including a plurality of fasteners that connect the first flange to the second flange at a position that is outside the gasket seal relative to the interior area.

In some aspects, the techniques described herein relate to an assembly, wherein the intumescent is configured to expand to seal an interface between the first and second flanges at the position.

In some aspects, the techniques described herein relate to an assembly, wherein the first and second flanges project outward from the interior area past the gasket seal, wherein the first flange and the second flange are spaced a distance from each other in the areas outside the gasket seal relative to the interior area.

In some aspects, the techniques described herein relate to an assembly, further including a mechanical fastener that secures the first flange to the second flange at a position outside the gasket seal relative to the interior area.

In some aspects, the techniques described herein relate to an assembly, wherein the first and second flanges project outward in a horizontal direction, wherein the first flange is spaced a distance vertically from the second flange in the areas outside the gasket seal relative to the interior area.

In some aspects, the techniques described herein relate to an assembly, wherein, in areas outside the gasket seal relative to the interior area, no portion of the first flange contacts any portion of the second flange.

In some aspects, the techniques described herein relate to an assembly, further including at least one array of battery cells disposed within the interior area.

In some aspects, the techniques described herein relate to an assembly, wherein the gasket seal extends circumferentially continuously about the interior area.

In some aspects, the techniques described herein relate to an assembly, wherein the first piece is an enclosure cover of a battery enclosure, and the second piece is an enclosure tray of the battery enclosure.

In some aspects, the techniques described herein relate to an enclosure securing method, including: sealing an interface by compressing a gasket seal between a first flange of a first piece of an enclosure and a second flange of a second piece of the enclosure, the enclosure providing an interior area that houses a plurality of battery cells; and shielding the gasket seal from thermal energy using an intumescent.

In some aspects, the techniques described herein relate to an enclosure securing method, wherein the intumescent is sandwiched between the first and second flange at a position that is between the gasket seal and the interior area.

In some aspects, the techniques described herein relate to an enclosure securing method, wherein the intumescent expands in response to thermal energy within the interior area, the expanding blocking at least some of the thermal energy from reaching the gasket seal.

In some aspects, the techniques described herein relate to an enclosure securing method, wherein the gasket seal extends circumferentially continuously about a perimeter of the interior area.

In some aspects, the techniques described herein relate to an enclosure securing method, further including spacing the first flange a distance from the second flange at a position that is outside the gasket seal relative to the interior area.

In some aspects, the techniques described herein relate to an enclosure securing method, further including mechanically fastening the first flange to the second flange at a position that is outboard the gasket seal.

In some aspects, the techniques described herein relate to an enclosure securing method, wherein the first flange and the second flange are spaced from each other outside the gasket seal such that an area of the gasket seal is exposed.

In some aspects, the techniques described herein relate to an enclosure securing method, further including holding at least one array of battery cells within the interior area.

In some aspects, the techniques described herein relate to an enclosure securing method, wherein the enclosure is a battery pack enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle having a traction battery.

FIG. 2 illustrates an expanded view of selected portions of the traction battery pack from the vehicle of FIG. 1.

FIG. 3 illustrates the traction battery pack of FIG. 2 when assembled.

FIG. 4 illustrates a close-up view of Area 4 in FIG. 3.

FIG. 5 illustrates a section view taken at line 5-5 in FIG. 4.

### DETAILED DESCRIPTION

Traction battery packs can include cell stacks within an enclosure. Each of the cell stacks within the enclosure can each include a plurality of individual battery cells. Enclosure pieces are joined to provide the enclosure. Interfaces between the enclosure pieces can be sealed to prevent contaminants and moisture from moving into the interior area.

Occasionally, a thermal propagation event could lead to increased pressure and temperature in one of the battery cells. The increasing pressure and temperature can rupture the battery cell, which results in a venting of gas from the interior of the battery cell. The disclosure, in particular, details assemblies and methods that can shield sealed areas from vented gas so that vented gas releases to the ambient environment through desired areas rather than through the sealed interfaces between the enclosure pieces. In particular, this disclosure details assemblies and methods associated with using an intumescent to shield a traction battery pack seal from thermal energy.

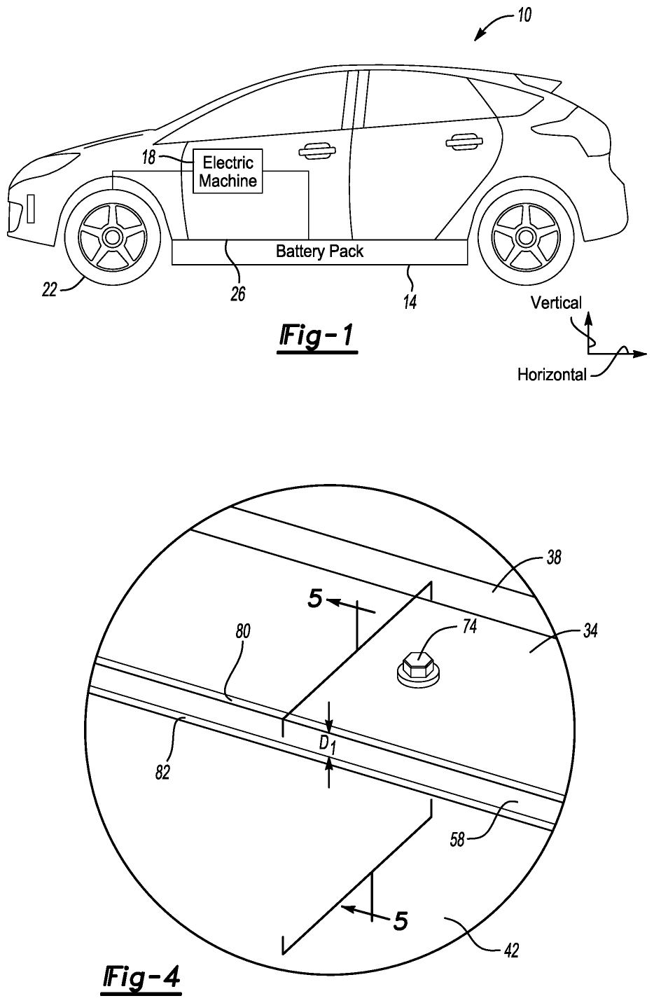

With reference to FIG. 1, an electrified vehicle 10 includes a traction battery pack 14, an electric machine 18, and wheels 22. The traction battery pack 14 powers an electric machine 18, which can convert electrical power to torque to drive the wheels 22.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

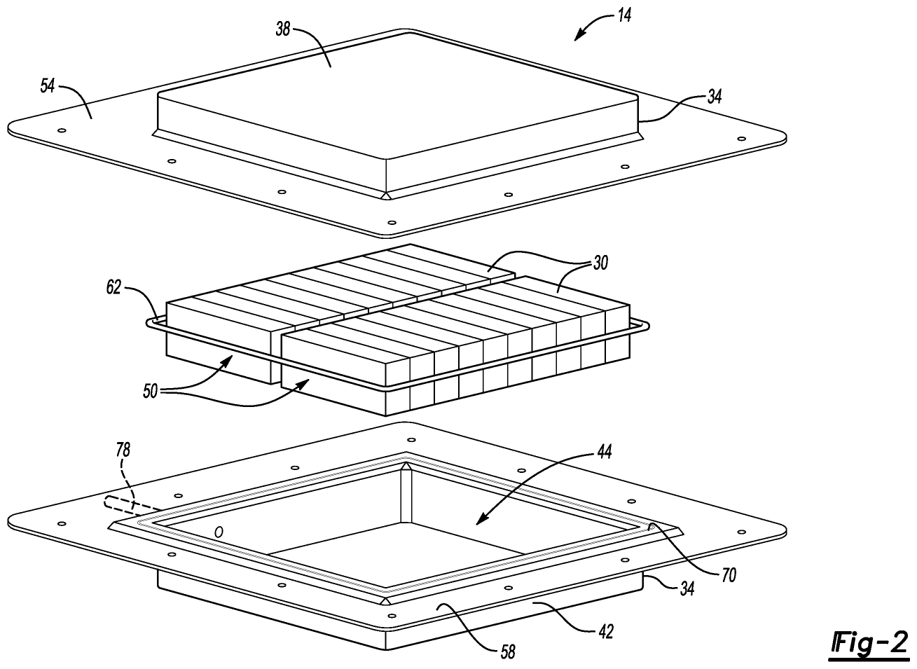

With reference now to FIG. 2, the traction battery pack 14 includes a plurality of battery cells 30 disposed within an enclosure assembly 34. In the exemplary embodiment, the enclosure assembly 34 comprises various enclosure pieces. In particular, the example enclosure assembly 34 includes an enclosure cover 38 and an enclosure tray 42.

The enclosure cover 38 and enclosure tray 42 are secured together to provide an interior area 44 that houses the plurality of battery cells 30. The battery cells 30 can be grouped into arrays 50. The example enclosure assembly 34 houses two arrays 50 along with other components, busbars, modules, wiring harnesses, etc. of the traction battery pack 14.

The enclosure cover 38 includes a first flange 54 that projects outward from the interior area 44. The enclosure tray 42 includes a second flange 58 that projects outward from the interior area 44. The first flange 54 and the second flange 58 project horizontally in this example, but could project on other directions. Horizontal and vertical, for purposes of this disclosure, are with reference to ground and a general orientation of the vehicle electrified during operation.

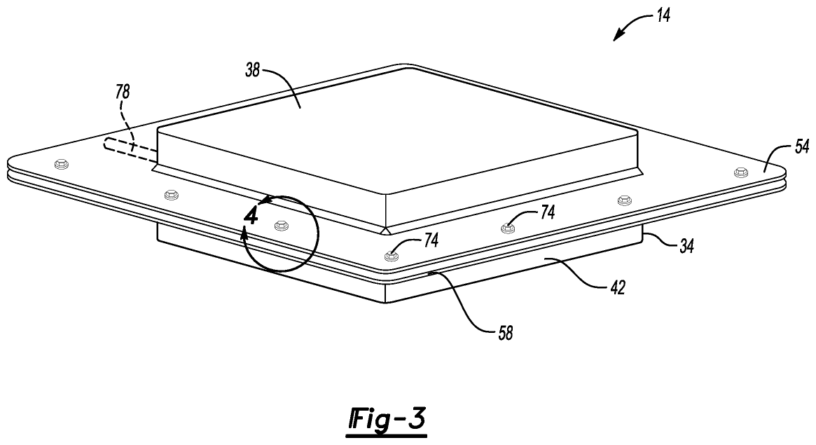

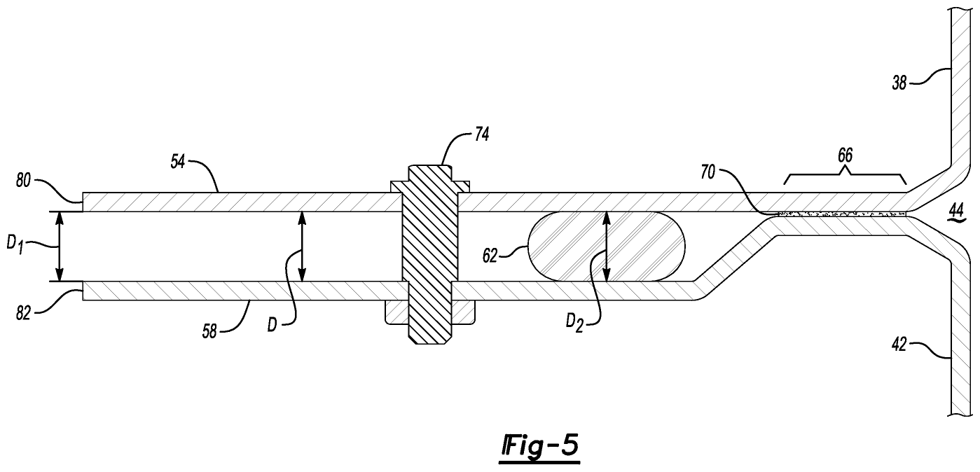

When the enclosure cover 38 and the enclosure tray 42 and in the assembled position of FIGS. 3-5, a gasket seal 62 or “sealing ring” is compressed and sandwiched between the first flange 54 and the second flange 58. The gasket seal 62 extends circumferentially continuously about the interior area 44. The gasket seal 62 blocks moisture and contaminants from entering the interior area 44.

Inside the gasket seal 62 relative to the interior area 44, the first flange 54 and second flange 58 meet at a flange-to-flange interface 66. An intumescent 70 is sandwiched between the first flange 54 and the second flange 58 along the flange-to-flange interface 66. The intumescent 70 is a substance that swells when exposed to thermal energy. The swelling increases a volume of the substance and decreases a density of the substance. In this example, the intumescent 70 is a coating that is applied to the enclosure tray 42 prior to securing together the enclosure cover 38 and the enclosure tray 42.

The intumescent 70 and the flange-to-flange interface 66 extend circumferentially continuously about a perimeter of the interior area 44. In this example, the flange-to-flange interface 66 is at least five millimeters wide in this example.

Outside the gasket seal 62 relative to the interior area 44 are a plurality of mechanical fasteners 74 that connect the enclosure cover 38 to the enclosure tray 42.

If a thermal propagation event in the interior area 44 results in thermal energy increasing above a threshold level, the intumescent 70 expands to help block vented gas (and thermal energy) from impinging directly on the gasket seal 62. This can help to maintain the integrity of the gasket seal 62 and can ensure that the vented gas and thermal energy is communicated from the interior area 44 in a desired area, such as through a vent port 78.

To further help reduce an amount of energy thermal energy near the gasket seal 62 during a thermal propagation event, the first flange 54 and the second flange 58 both project outward past the gasket seal 62 and, in this area just outboard the gasket seal 62, the first flange 54 and the second flange 58 are spaced vertically a distance D from each other. In this example, in areas outside the gasket seal 62 relative to the interior area 44, no portion of the first flange 54 contacts any portion of the second flange 58.

The distance D between the first flange 54 and the second flange 58 just outside the gasket seal 62 is, in this example, the same as a distance D1 between an outermost edge 80 of the first flange 54 and an outermost edge 82 of the second flange 58. Also, the distance D just outside the gasket seal 62 is the same as a distance D2 between the first flange 54 and the second flange 58 where the gasket seal 62 is sandwiched between the first flange 54 and the second flange 58. In this example, the mechanical fastener 74 is a shoulder bolt that helps to maintain the desired spacing between the first flange 54 and the second flange 58. In another examples, a bushing could be used to maintain the spacing between the first flange 54 and the second flange 58 instead of a shoulder bolt. Due to the spacing of the first flange 54 from the second flange 58, an outward facing side of the gasket seal 62 is exposed to an ambient environment in this example.

The extension and spacing of the first flange 54 and the second flange 58 can increase surface area available for transferring thermal energy from the first flange 54 and the second flange 58 to the ambient air surrounding the enclosure assembly 34. Thermal energy can radiate to ambient from the first flange 54 and the second flange 58 rather than disrupting the integrity of the gasket seal.

In this example, the enclosure cover 38 and the enclosure tray 42 are a metal or metal alloy. In other examples, other materials could be used. One or both of the enclosure cover 38 and enclosure tray 42 could be a stamping, an extruded component, or a diecast component.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a first piece of an enclosure having an interior area, the first piece including a first flange that projects outward from the interior area,
a second piece of the enclosure, the second piece including a second flange that projects outward from the interior area; and
a gasket seal sandwiched between the first and second flanges; and
an intumescent sandwiched between the first and second flange at a position that is between the gasket seal and the interior area.

2. The assembly of claim 1, further comprising a plurality of fasteners that connect the first flange to the second flange at a position that is outside the gasket seal relative to the interior area.

3. The assembly of claim 1, wherein the intumescent is configured to expand to seal an interface between the first and second flanges at the position.

4. The assembly of claim 1, wherein the first and second flanges project outward from the interior area past the gasket seal, wherein the first flange and the second flange are spaced a distance from each other in the areas outside the gasket seal relative to the interior area.

5. The assembly of claim 4, further comprising a mechanical fastener that secures the first flange to the second flange at a position outside the gasket seal relative to the interior area.

6. The assembly of claim 4, wherein the first and second flanges project outward in a horizontal direction, wherein the first flange is spaced a distance vertically from the second flange in the areas outside the gasket seal relative to the interior area.

7. The assembly of claim 1, wherein, in areas outside the gasket seal relative to the interior area, no portion of the first flange contacts any portion of the second flange.

8. The assembly of claim 1, further comprising at least one array of battery cells disposed within the interior area.

9. The assembly of claim 1, wherein the gasket seal extends circumferentially continuously about the interior area.

10. The assembly of claim 1, wherein the first piece is an enclosure cover of a battery enclosure, and the second piece is an enclosure tray of the battery enclosure.

11. An enclosure securing method, comprising:
sealing an interface by compressing a gasket seal between a first flange of a first piece of an enclosure and a second flange of a second piece of the enclosure, the enclosure providing an interior area that houses a plurality of battery cells; and
shielding the gasket seal from thermal energy using an intumescent.

12. The enclosure securing method of claim 11, wherein the intumescent is sandwiched between the first and second flange at a position that is between the gasket seal and the interior area.

13. The enclosure securing method of claim 11, wherein the intumescent expands in response to thermal energy within the interior area, the expanding blocking at least some of the thermal energy from reaching the gasket seal.

14. The enclosure securing method of claim 11, wherein the gasket seal extends circumferentially continuously about a perimeter of the interior area.

15. The enclosure securing method of claim 11, further comprising spacing the first flange a distance from the second flange at a position that is outside the gasket seal relative to the interior area.

16. The enclosure securing method of claim 11, further comprising mechanically fastening the first flange to the second flange at a position that is outboard the gasket seal.

17. The enclosure securing method of claim 11, wherein the first flange and the second flange are spaced from each other outside the gasket seal such that an area of the gasket seal is exposed.

18. The enclosure securing method of claim 11, further comprising holding at least one array of battery cells within the interior area.

19. The enclosure securing method of claim 11, wherein the enclosure is a battery pack enclosure.
